(19) United States
(12) Patent Application Publication
(10) Pub. No.: US 2016/0378458 A1
(43) Pub. Date: Dec. 29, 2016

(54) METHOD AND DEVICE FOR SYSTEM APPLICATION INSTALLATION PACKAGE, AND TERMINAL

(71) Applicant: ZTE CORPORATION, Shenzhen, Guangdong (CN)

(72) Inventors: Haojie PAN, Shenzhen (CN); Qixing TIAN, Shenzhen (CN); Xiaorui LIU, Shenzhen (CN)

(21) Appl. No.: 15/100,116

(22) PCT Filed: Jun. 5, 2014
(86) PCT No.: PCT/CN2014/079294

§ 371 Date: Jun. 23, 2016

(30) Foreign Application Priority Data
Nov. 28, 2013 (CN) 201310624799.7

(51) Int. Cl. G06F 9/445; G06F 11/14

(52) U.S. Cl. CPC G06F 8/65; G06F 8/61; G06F 11/1433; G06F 2201/84

(57) ABSTRACT

The embodiments of disclosure provide a method and device for loading a system Application (APP) installation package, and a terminal. The method includes that: before update processing of a system APP installation package, the system APP installation package is renamed as a system APP installation backup package; whether loading according to a system APP installation update package is successful is judged, wherein the system APP installation update package is the system APP installation package acquired after updating a copied version formed by copying the system APP installation backup package; and in a case that a judging result is that loading according to the system APP installation update package is not successful, loading is performed according to the system APP installation backup package, thereby achieving the effect of improving system stability and user experience.

### TECHNICAL FIELD

The disclosure relates to the communications field, and in particular to a method and device for loading a system Application (APP) installation package, and a terminal.

### BACKGROUND

With a popularity of Android smart phones, development of matched upper layer APPs is also growing rapidly, and massive free Android Packages (APK) will be provided on a network at any time for downloading, installation and using. Against this background, it has become an important scenario in usage of smart phones to install and uninstall an APK by a user on an Android smart phone terminal. An APP package management component in an Android system is a special functional component for this scenario. A packager manager service, which is a JAVA layer service started by a system server during a system startup phase, is used for manage APK files in catalogues /system/framework, /system/app, /data/app, and /data/app-private, mainly including the following working steps:

Step 1: an installd socket link between an installer of a java layer and a c layer is created, so that functions including install, remove, dexopt and so on of an upper layer may be eventually implemented by installd at a bottom layer;

Step 2: a PackageHandler message ring is created to process an external apk installation request message, e.g. a message may be sent when an apk is installed by adb install, packageinstaller;

Step 3: an xml file (framework/base/data/etc/) under catalogue /system/etc/permission is parsed, including platform.xml and features of various hardware components supported by the system;

(1) mapping relations between user Identifiers (ID) as well as group IDs of the bottom layer and permissions of the upper layer are created, and it may be designated the one permission corresponds to several group IDs; when authorized to have the permission, an APK also belongs to these groups at the same time;

(2) permissions are allocated to some bottom layer users, e.g. various permissions are granted to a shell; a User Identification (UID) is assigned to a permission, and when a progress uses this UID to operate, the progress is granted with the permission;

(3) a library, is an extended jar library which is added to the system and needs to be linked by some APPs;

(4) a feature, a corresponding feature will be added each time when a piece of hardware is added to the system; a parsing result is inputted into several sets including mSystemPermissions, mSharedLibraries, mSettings.mPermissions, mAvailableFeatures and so on for system query and permission configuration;

Step 4: whether /data/system/packages.xml exists is checked; this file is created by writeLP ( ) when apks are parsed, and records permissions of the system, and information including a name, a codePath, flags, ts, a version, and a userid and so on of each apk; this information is mainly acquired by parsing AndroidManifest.xml of the apk, and after the apk is parsed, updated information is written into the file and saved in flash; related information is read directly during the next startup, and added to a related list of a memory; when an apk is upgraded, the file will be updated when the apk is installed or deleted;

Step 5: whether jar under BootClassPath, mSharedLibraries and /system/framework requires dexopt is checked, and jar that requires dexopt is optimized through dexopt;

Step 6: an AppDirObserver thread is started to monitor events of catalogs /system/framework, /system/app, /data/app, and /data/app-private, mainly monitoring events including add, and remove; a category monitoring bottom layer is implemented by an inotify mechanism; inotify is a change notification mechanism of a file system, e.g. events including addition, deletion and so on of a file may be learned by a user mode immediately; inotify provides powerful support for the user mode to monitor changes of the file system; scanPackageLI (File, int, int) is invoked for processing when there is an add even, and removePackageLI ( ) is invoked for processing when there is a remove event;

Step 7: apks under the catalogues above are parsed one by one; mainly, a AndroidMa-nifest.xml file of each apk is parsed, resource files including asset/res and so on are processed, configuration structure information of each apk is created, and the configuration structure information of each apk is added to a global list for management; installer.install ( ) is invoked for installation; whether a dex file in an apk needs to be further optimized is checked, and if the dex file in the apk needs to be further optimized, optimization processing is performed by an auxiliary tool dexopt; a component acquired through parsing is added to a corresponding list of pkg; and the apk is signed and subjected to certificate verification so as to complete integrity verification;

Step 8: information of each parsed apk is stored in files packages.xml and packages.list; the following data is recorded in packages.list: pkgName, userId, debugFlag, and dataPath.

It may be seen from the working flow of the whole Android APP package management service that information including name, codePath, flags, ts, version, userid and so on of each changed apk will be updated each time when an APP is installed or uninstalled. This information is mainly acquired by parsing AndroidManifest.xml of the apk, and after the apk is parsed, the updated information is written in Package.xml and saved in flash. Related information is read directly therein during the next startup, and added to a related list of a memory. During the installing or uninstalling process of the APP, Package.xml will be copied, and a backup file will be generated again. During this process, an error of any link, particularly data loss during the copying process, will result in a data exception in Package.xml and a loading failure during the next startup, thus resulting in a startup failure of a mobile phone. According to information fed back by the Internet, many users fail to start mobile phones after using the Android smart phones for a period of time, and it is been many times that startup cannot be performed normally due to a data exception of Package.xml when malfunctioning devices are analyzed in practice. In this case, recovery may be achieved only by creating a mobile phone software version at an after-sales outlet, but resulting loss of user data is a very serious problem.

### SUMMARY

The embodiments of disclosure provide a method and device for loading a system APP installation package, and a terminal, so as to at least solve a problem in the related art that a terminal is unable to start due to a data exception in a system APP installation package caused by an error made when a backup file is generated by copying the system APP installation package.

A method for loading a system APP installation package is provided according to an embodiment of the disclosure, including that: before update processing of a system APP installation package, renaming the system APP installation package as a system APP installation backup package; judging whether loading according to a system APP installation update package is successful, wherein the system APP installation update package is a system APP installation package acquired after updating a copied version formed by copying the system APP installation backup package; and in a case that a judging result is that the loading according to the system APP installation update package is not successful, performing loading according to the system APP installation backup package.

In an example embodiment, after performing the loading according to the system APP installation backup package, the method further includes: judging whether the loading according to the system APP installation backup package is successful; in a case that a judging result is that the loading according to the system APP installation update package is not successful, acquiring an initial system APP installation package used during a first loading of a system device after delivery and, when the system APP installation package is updated each time, a different part of the updated system APP installation package relative to the initial system APP installation package; combining the initial system APP installation package with the acquired different part to obtain a combined system APP installation package; and performing the loading according to the combined system APP installation package.

In an example embodiment, acquiring the initial system APP installation package used during the first loading of the system device after the delivery includes: renaming an initial system APP installation package generated during the first loading of the system device after the delivery as the initial system APP installation package.

In an example embodiment, after performing the loading according to the combined system APP installation package, the method further includes: judging whether the loading according to the combined system APP installation package is successful; in a case that a judging result is that the loading according to the combined system APP installation package is not successful, generating a system APP installation scanning package through scanning an APP installed to the system; and performing the loading according to the system APP installation scanning package.

In an example embodiment, after performing the loading according to the system APP installation scanning package, the method further includes: judging whether the loading according to the system APP installation scanning package is successful; and in a case that a judging result is that the loading according to the system APP installation scanning package is not successful, performing the loading according to the initial system APP installation package generated during the first loading of the system device after the delivery.

A device for loading a system APP installation package is provided according to another embodiment of the disclosure, including:

a renaming component configured to, before update processing of a system APP installation package, rename the system APP installation package as a system APP installation backup package; a first judging component, configured to judge whether loading according to a system APP installation update package is successful, wherein the system APP installation update package is a system APP installation package acquired after updating a copied version formed by copying the system APP installation backup package; and a first loading component configured to, in a case that a judging result is that loading according to the system APP installation update package is not successful, perform loading according to the system APP installation backup package.

In an example embodiment, the device further includes: a second judging component, configured to judge whether the loading according to the system APP installation backup package is successful; an acquiring component configured to, in the case that a judging result is that loading according to the system APP installation update package is not successful, acquire an initial system APP installation package used during a first loading of a system device after delivery and, when the system APP installation package is updated each time, a different part of the updated system APP installation package relative to the initial system APP installation package; a combining component, configured to combine the initial system APP installation package with the acquired different part to obtain a combined system APP installation package; and a second loading component, configured to perform the loading according to the combined system APP installation package.

In an example embodiment, the acquiring component includes: a renaming element, configured to rename an initial system APP installation package generated during the first loading of the system device after the delivery as the initial system APP installation package.

In an example embodiment, the device further includes: a third judging component, configured to judge whether the loading according to the combined system APP installation package is successful; a generating component configured to, in a case that a judging result is that the loading according to the combined system APP installation package is not successful, generate a system APP installation scanning package through scanning an APP installed to the system; and a third loading component, configured to perform the loading according to the system APP installation scanning package.

In an example embodiment, the device further includes: a fourth judging component, configured to judge whether the loading according to the system APP installation scanning package is successful; and a fourth loading component configured to, in a case that a judging result is that the loading according to the system APP installation scanning package is not successful, perform the loading according to the initial system APP installation package generated during the first loading of the system device after the delivery.

A terminal is provided according to another embodiment of the disclosure, including any device for loading the system APP installation package as mentioned above.

By means of the embodiments of the disclosure, before update processing of a system APP installation package, the system APP installation package is renamed as a system APP installation backup package; whether loading according to a system APP installation update package is successful is judged, wherein the system APP installation update package is the system APP installation package acquired after updating a copied version formed by copying the system APP installation backup package; and in a case that a judging result is that loading according to the system APP installation update package is not successful, loading is performed according to the system APP installation backup package. The disclosure solves the problem in the related art that a terminal is unable to start due to a data exception in a system APP installation package caused by an error made when a backup file is generated by copying the system APP installation package, thereby achieving the effect of improving system stability and user experience.

### BRIEF DESCRIPTION OF THE DRAWINGS

The accompanying drawings described herein are used for providing further understanding to the disclosure and form a part of the present application. The schematic embodiments of the disclosure and the description thereof are used for explaining the disclosure, instead of forming improper limitation thereto. In the accompanying drawings:

FIG. 1 is a flowchart of a method for loading a system APP installation package according to an embodiment of the disclosure;

FIG. 2 is a structural block diagram of a device for loading a system APP installation package according to an embodiment of the disclosure;

FIG. 3 is a structural block diagram of a device for loading a system APP installation package according to a first example embodiment of the disclosure;

FIG. 4 is a structural block diagram of an acquiring component 34 in the structural block diagram of the device for loading the system APP installation package according to a first example embodiment of the disclosure;

FIG. 5 is a structural block diagram of a device for loading a system APP installation package according to a second example embodiment of the disclosure;

FIG. 6 is a structural block diagram of a device for loading a system APP installation package according to a third example embodiment of the disclosure;

FIG. 7 is a structural block diagram of a terminal 72 according to an embodiment of the disclosure;

FIG. 8 is a flowchart of data generation of a method for error-tolerant of Android APP package management according to an embodiment of the disclosure; and

FIG. 9 is a flowchart of data usage of a method for error-tolerant of Android APP package management according to an embodiment of the disclosure.

### DETAILED DESCRIPTION

The disclosure will be expounded hereinafter with reference to the accompanying drawings and in combination with the embodiments. It needs to be noted that the embodiments in the present application and the characteristics in the embodiments may be combined with each other if there is no conflict.

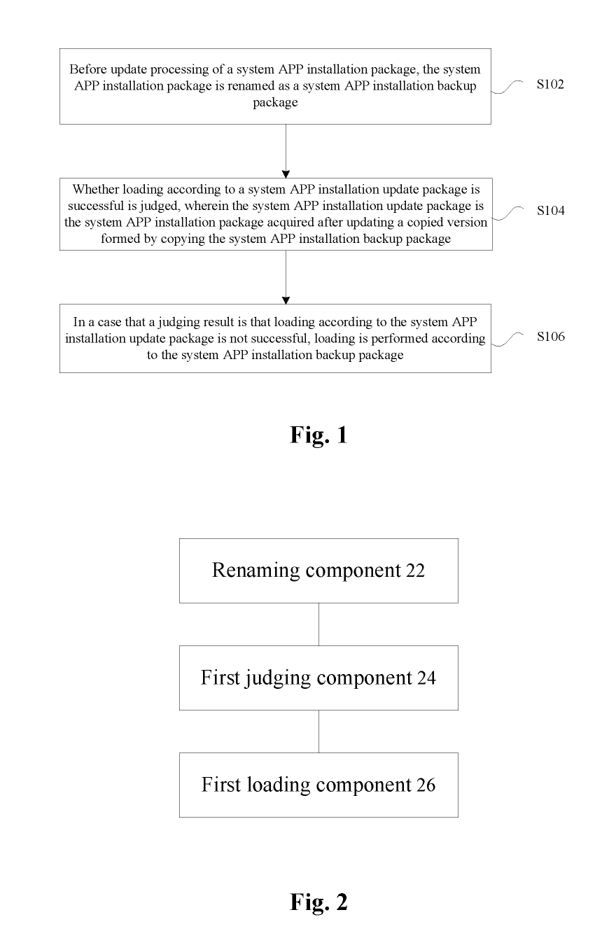

The present embodiment provides a method for loading a system APP installation package. FIG. 1 is a flowchart of a method for loading a system APP installation package according to an embodiment of the disclosure. As shown in FIG. 1, the flow includes the following steps.

Step 102: Before update processing of a system APP installation package, the system APP installation package is renamed as a system APP installation backup package.

Step 104: Whether loading according to a system APP installation update package is successful is judged, wherein the system APP installation update package is the system APP installation package acquired after updating a copied version formed by copying the system APP installation backup package.

Step 106: In a case that a judging result is that loading according to the system APP installation update package is not successful, loading is performed according to the system APP installation backup package.

By means of the steps above, before update processing of a system APP installation package, the system APP installation package is renamed as a system APP installation backup package; then the system APP installation backup package is copied, and the copied system APP installation backup package is updated; when the system APP installation package of updated by a system APP is loaded unsuccessfully, loading processing is performed according to the system APP installation backup package; the system APP installation backup package is not generated after copying, thus effectively avoiding a problem of an backup copy error, and solving the problem in the related art that a terminal is unable to start due to a data exception in a system APP installation package caused by an error made when a backup file is generated by copying the system APP installation package, thereby achieving the effect of improving system stability and user experience.

In order to better implement an error-tolerant mechanism of the method mentioned above, whether the loading according to the system APP installation backup package is successful may be further judged after the loading is performed according to the system APP installation backup package; in the case that a judging result is that loading according to the system APP installation update package is not successful, an initial system APP installation package used during a first loading of a system device after delivery and when the system APP installation package is updated each time, a different part of the updated system APP installation package relative to the initial system APP installation package are acquired; the initial system APP installation package is combined with at least one acquired different part to obtain a combined system APP installation package; and the loading is performed according to the combined system APP installation package. In this way, it may be ensured that normal startup and normal operation of the terminal may be maintained when the system APP installation backup package is loaded unsuccessfully. The combined system APP installation package functions as a substitute of the system APP installation backup package, thereby well ensuring normal usage of the terminal.

Further the initial system APP installation package used during the first loading of the system device after the delivery may be acquired according to a plurality of methods. For example, a direct copy method may be applied, and a safer method may be also applied. For example, the following processing methods may be applied for implementation: an initial system APP installation package generated during the first loading of the system device after the delivery is renamed as the initial system APP installation package. In other words, the initial system APP installation package is an original system APP installation package used during a first startup of the terminal after the delivery or during the first startup after restoration of factory settings.

In order to implement error tolerance in more dimensions, after the loading is performed according to the combined system APP installation package, the method may further include that: whether the loading according to the combined system APP installation package is successful is judged; in a case that a judging result is that the loading according to the combined system APP installation package is not successful, a system APP installation scanning package is generated through scanning an APP installed to the system; and the loading is performed according to the system APP installation scanning package. Such a scenario is triggered with little probability, but is effective in solving the problem that the terminal fails to perform startup normally and fails to work normally. An error-tolerant mechanism of a higher dimension may be implemented by generating the system APP installation scanning package again.

In an example embodiment, the following processing may be also applied in order to ensure normal use of a user when startup of the terminal cannot be implemented by the mechanism mentioned above: after the loading is performed according to the system APP installation scanning package, the method further includes that: whether the loading according to the system APP installation scanning package is successful is judged; and in a case that a judging result is that the loading according to the system APP installation scanning package is not successful, the loading processing is performed according to the initial system APP installation package generated during the first loading of the system device after the delivery. The terminal may be restored to a phase of factory settings according to the method. Although data of all new APPs of the user will lose, it may be ensured that the mobile phone is in a usable state, and it is unnecessary to upgrade a version at an after-sales outlet, thereby improving the efficiency for the terminal to recover normal operation.

The present embodiment further provides a device for loading a system APP installation package. The device is configured to implement the embodiments and example embodiments above, and what has been described will not be repeated. As used below, the term “component” may implement a combination of software and/or hardware having a predetermined function. Although a device described in the following embodiments is example implemented by software, implementation using hardware or a combination of software and hardware is also possible and conceivable.

FIG. 2 is a structural block diagram of a device for loading a system APP installation package according to an embodiment of the disclosure. As shown in FIG. 2, the device includes a renaming component 22, a first judging component 24 and a first loading component 26. The structural block diagram of the device for loading the system APP installation package will be described below.

The renaming component 22 is configured to, before update processing of a system APP installation package, rename the system APP installation package as a system APP installation backup package; the first judging component 24 is connected to the renaming component 22 and configured to judge whether loading according to a system APP installation update package is successful, wherein the system APP installation update package is a system APP installation package acquired after updating a copied version formed by copying the system APP installation backup package; and the first loading component 26 is connected to the first judging component 24 and configured to, in a case that a judging result is that loading according to the system APP installation update package is not successful, perform loading according to the system APP installation backup package.

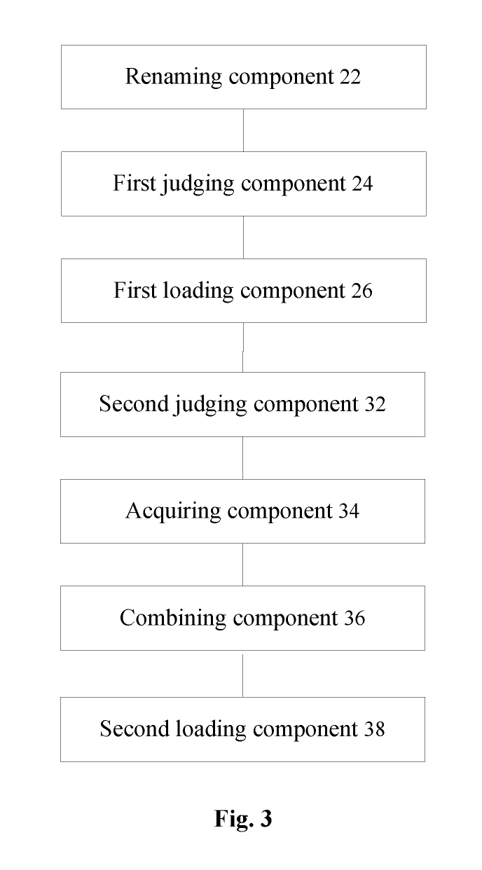

FIG. 3 is a structural block diagram of a device for loading a system APP installation package according to a first example embodiment of the disclosure. As shown in FIG. 3, besides all components as shown in FIG. 2, the device for loading the system APP installation package further includes: a second judging component 32, an acquiring component 34, a combining component 36 and a second loading component 38. The structural block diagram of the device for loading the system APP installation package according to the first example embodiment will be described below.

The second judging component 32 is connected to the first loading component 26 and configured to judge whether the loading according to the system APP installation backup package is successful; the acquiring component 34 is connected to the second judging component 32 and configured to, in the case that a judging result is that loading according to the system APP installation update package is not successful, acquire an initial system APP installation package used during a first loading of a system device after delivery and, when the system APP installation package is updated each time, a different part of the updated system APP installation package relative to the initial system APP installation package; the combining component 36 is connected to the acquiring component 36 and configured to combine the initial system APP installation package with at least one acquired different part to obtain a combined system APP installation package; and the second loading component 38 is connected to the combining component 36 and configured to perform the loading according to the combined system APP installation package.

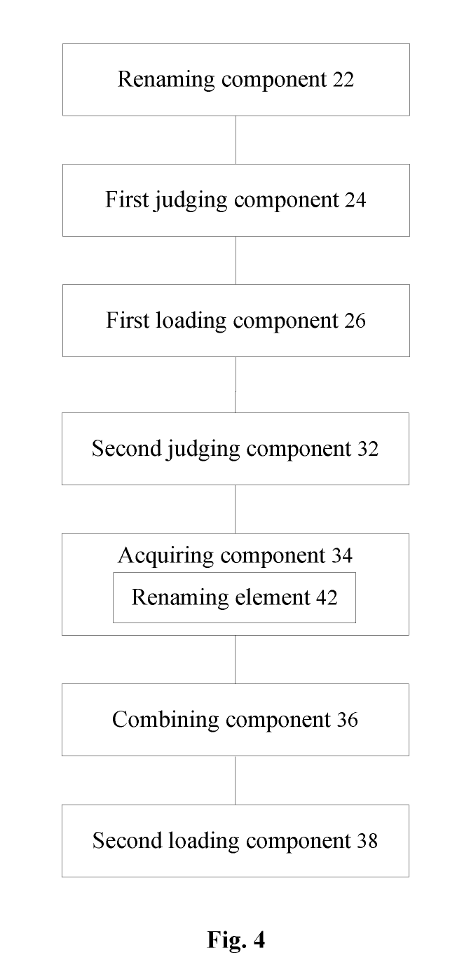

FIG. 4 is a structural block diagram of the acquiring component 34 in the structural block diagram of the device for loading the system APP installation package according to a first example embodiment of the disclosure. As shown in FIG. 4, the acquiring component 34 includes: a renaming element 42. The acquiring component 34 will be described below.

The renaming component 42 is configured to rename an initial system APP installation package generated during the first loading of the system device after the delivery as the initial system APP installation package.

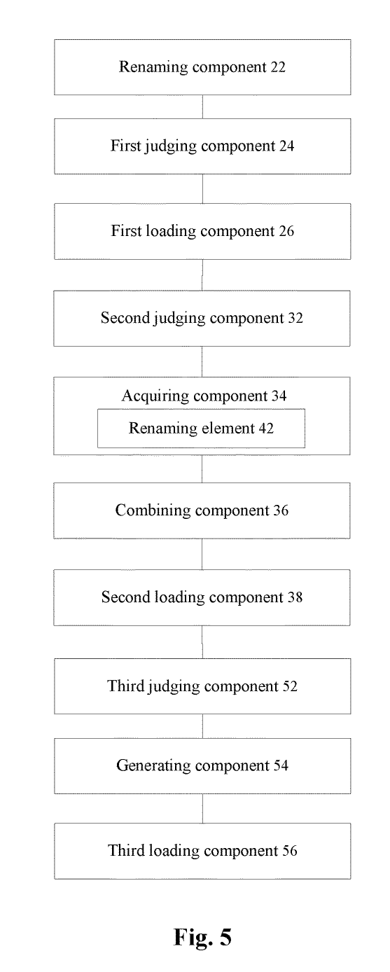

FIG. 5 is a structural block diagram of a device for loading a system APP installation package according to a second example embodiment of the disclosure. As shown in FIG. 5, besides all components as shown in FIG. 4, the structural block diagram of the device for loading the system APP installation package further includes: a third judging component 52, a generating component 54 and a third loading component 56. The structural block diagram of the device for loading the system APP installation package according to the second example embodiment will be described below.

The third judging component 52 is connected to the second loading component 38 and configured to judge whether the loading according to the combined system APP installation package is successful; the generating component 54 is connected to the third judging component 52 and configured to, in a case that a judging result is that the loading according to the combined system APP installation package is not successful, generate a system APP installation scanning package through scanning an APP installed to the system; and the third loading component 56 is connected to the generating component 54 and configured to perform the loading according to the system APP installation scanning package.

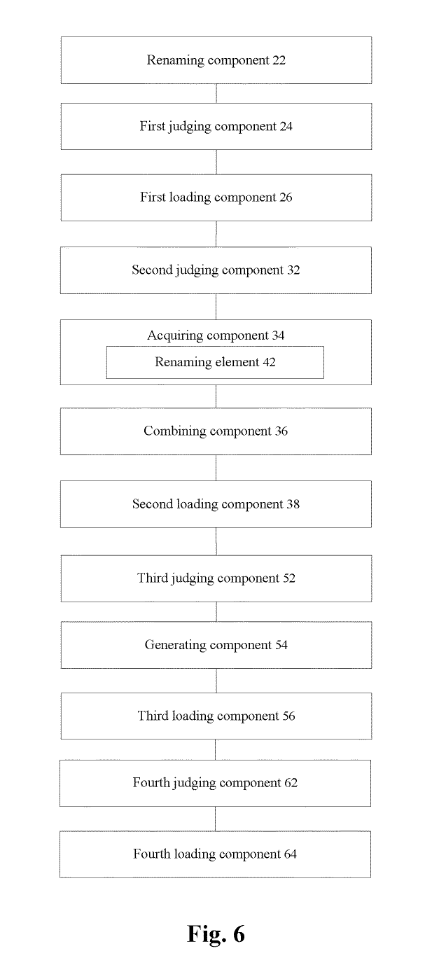

FIG. 6 is a structural block diagram of a device for loading a system APP installation package according to a third example embodiment of the disclosure. As shown in FIG. 6, besides all components as shown in FIG. 5, the structural block diagram of the loading device for the system APP installation package further includes: a fourth judging component 62 and a fourth loading component 64. The structural block diagram of the device for loading the system APP installation package according to the third example embodiment will be described below.

The fourth judging component 62 is connected to the third loading component 56 and configured to judge whether the loading according to the system APP installation scanning package is successful; and the fourth loading component 64 is connected to the fourth judging component 62 and configured to, in a case that a judging result is that the loading according to the system APP installation scanning package is not successful, perform the loading processing according to the initial system APP installation package generated during the first loading of the system device after the delivery.

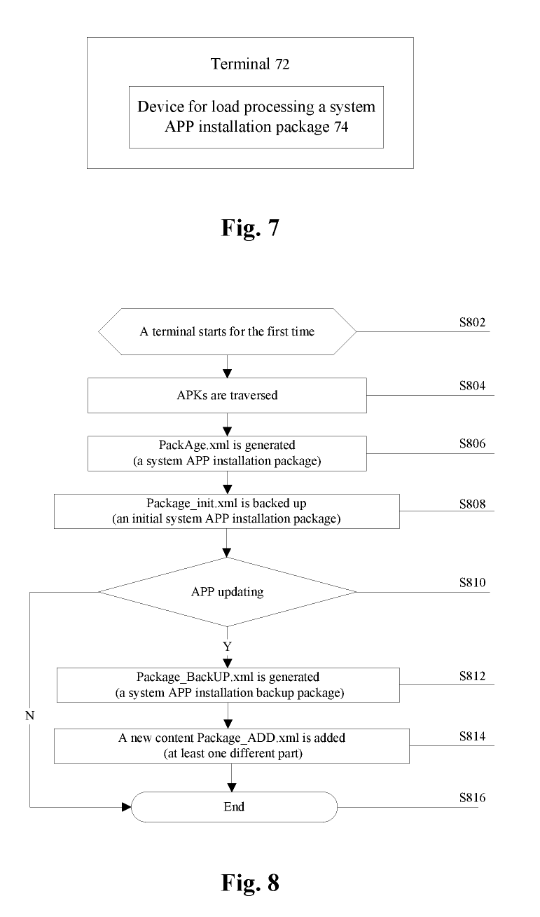

FIG. 7 is a structural block diagram of a terminal 72 according to an embodiment of the disclosure. As shown in FIG. 7, the terminal 72 includes any device 74 for loading the system APP installation package as mentioned above.

Directed at the problem in the related art that a terminal is unable to start due to a data exception in a system APP installation package caused by an error made when a backup file is generated by copying the system APP installation package, the present embodiment provides a method and device for loading a system APP installation package so as to at least solve the problem in the related art. Description will be provided below according to an Android system mobile phone as an example.

The present embodiment provides a method and system for error-tolerant of Android APP package management so as to solve the problem that a mobile phone is unable so start due to a data exception in Package.xml read and written for many times. A new set of multi-dimension cross error-tolerant protection mechanism is added in a whole operation flow of Package.xml so that it may be ensured that the mobile phone is able to normally for use regardless of a state of Package.xml saved in flash of the mobile phone. Each time when an APK is upgraded, installed or deleted and it is necessary to update Package.xml, the original Package.xml (i.e. the system APP installation package) is renamed as Package_BackUP.xml (i.e. the system APP installation backup package). During the next startup, the built-in Package.xml of the system is loaded first from a memory for startup. If the system judges that Package.xml is parsed abnormally, and thus the system fails to start normally, Package_BackUP.xml is used for startup so as to ensure that the mobile phone may start normally. If the built-in Package.xml can be used normally, Package_BackUP.xml is deleted after successful startup. Backup is performed again the next time when an APK is upgraded, installed or deleted. The error-tolerant mechanism is an error-tolerant protection measure in a first-dimension for the error-tolerant method and system in the Android APP package management. The introduction of the measure can greatly reduce the probability that the system fails to start normally due to an error caused by frequent reading of Package.xml.

The present embodiment further provides an example method for error-tolerant of Android APP package management. When a mobile phone starts for the first time after delivery or starts for the first time after restoring to factory settings, generated Package.xml is backed up and renamed as Package_Init.xml (which is the same as the initial system APP installation package), and saved as a primary file. The file is always saved under data/system/, and will not be deleted after successful startup. Each time when an APK is upgraded, installed or deleted and Package.xml is updated, an updated content is saved in a file Package_Add.xml (which is the same as the at least one acquired different part) separately, and the file is also saved under /data/system/ all the time, and updated as Package.xml of the system is updated, so as to record all differences from factory APPs. When Package_BackUP.xml becomes invalid, an error-tolerant mechanism in such a scenario is started to mix Package_Add.xml and Package_Init.xml to as to generate new Package.xml (which is the same as the combined system APP installation package) for use by the system.

The present embodiment further provides a solution for error-tolerant of Android APP package management so as to implement error tolerance of a system APP installation package in a higher dimension. In other words, an error-tolerant mechanism of a higher dimension is started when the error-tolerant mechanism above does not work. Package_BackUP.xml and Package.xml are deleted directly, and the system is enabled to scan all installed APPs again, and generate new Package.xml (which is the same as the system APP installation scanning package) according to information including name, code Path, flags, ts, version, user ID and so on of each APK. The probability that such a scenario is triggered is already extremely low. Since it is necessary to scan information of all installed APPs again, it will take more time for a mobile phone to start in this scenario.

The present embodiment further provides a solution for error-tolerant of Android APP package management when the error-tolerant mechanism above still fails to work. Package_Init.xml is directly started as a default configuration file, and a mobile phone restores to a phase of factory settings at the moment.

A solution for error-tolerant of Android APP package management according to an example embodiment of the disclosure will be described below with reference to the accompanying drawings.

FIG. 8 is a flowchart of data generation of a method for error-tolerant of Android APP package management according to an embodiment of the disclosure. As shown in FIG. 8, the flow includes the following steps.

Step 802: A terminal starts for the first time after a version is created or starts after restoring to factory settings, and a data area is empty in such a scenario.

Step 804: APK files under categories /system/framework, /system/app, /data/app, /data/app-private are scanned and Android Manifest.xml of the APKs are parsed to obtain information including system attributes, a package name, a code path, a flag, a version number and so on of each APK.

Step 806: A first copy of a Package.xml file of the system is generated according to the information.

Step 808: The first copy of the Package.xml file is backed up, copied to the data area, and renamed as Package_init.xml for use in a case of an error of the system.

Step 810: Whether operation including upgrading, installing, uninstalling and so on of an APK is performed is judged during an operation process of the mobile phone. If the operation is performed, the flow is terminated, and if the operation is not performed, Step 812 is performed.

Step 812: When the operation including upgrading, installing, uninstalling and so on of the APK is performed, it is necessary to update Package.xml, and before the updating, the original Package.xml in the data area is copied and renamed as Package_backUP.xml.

Step 814: A new content is written into Package_ADD.xml so as to record new APK information.

Step 816: The data generation process is terminated.

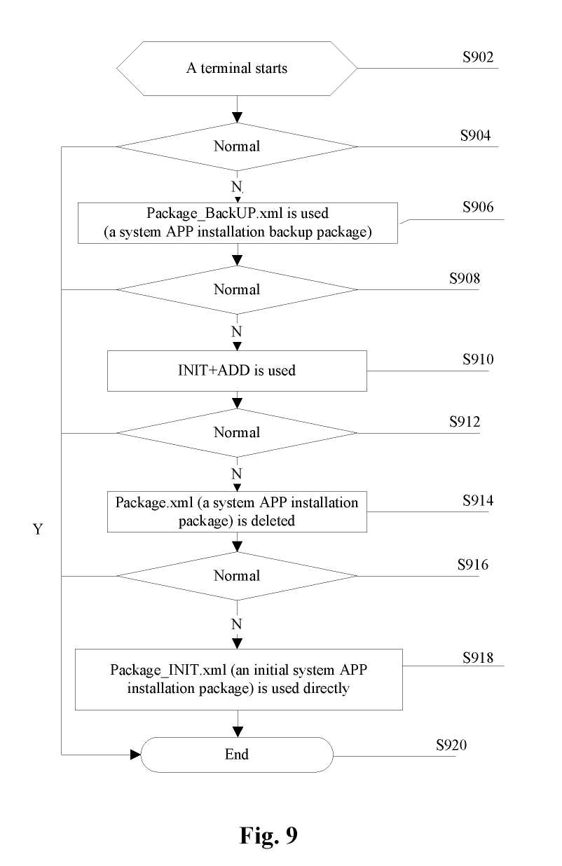

FIG. 9 is a flowchart of data usage of a method for error-tolerant of Android APP package management according to an embodiment of the disclosure. As shown in FIG. 9, the flow includes the following steps.

Step 902: A terminal starts.

Step 904: The system reads Package.xml and loads APP installation information. In this process, the system judges whether there is an abnormality, and if there is not an abnormality, Package.xml is used directly for startup, and an error-tolerant mechanism is unnecessary.

Step 906: When Package.xml cannot be used normally, the system uses Package_BackUP.xml for startup.

Step 908: The system judges whether the terminal can start normally, and if the terminal can start normally, uses Package_BackUP.xml directly for startup, and if the terminal cannot start normally, Step 910 is performed.

Step 910: The system reads Package_init.xml and Package_ADD.xml, merges the two, combines them into new package.xml, and uses the configuration for startup.

Step 912: Whether the terminal starts normally is judged.

Step 914: Package.xml is deleted, and the system is enabled to traverse all APK APPs, extract related information and generate new Package.xml for startup. Since it is necessary to traverse all APKs, the system will have a processing process in a period of time at the moment.

Step 916: Whether the terminal can start normally is judged.

Step 918: If the terminal still fails to start normally, Package_init.xml is used directly for startup. At the moment, data of all new APPs of the user will lose at the moment, but it can be ensured that the mobile phone is in a usable state in such an extreme condition and it is unnecessary to upgrade a version at an after-sales outlet.

Step 920: The startup process is terminated.

Obviously, those skilled in the art should understand that the components or steps of the disclosure may be implemented by a general computing device. They may be centralized on a single computing device or distributed in a network consisting of multiple computing devices. Optionally, they may be implemented by program codes executable by a computing device, so that they may be stored in a storage device and executed by the computing device, and in some cases, the steps as illustrated or described may be implemented according to sequences different from those described herein, or they may be respectively made into integrated circuit components or multiple components or steps in the components and steps may be made into a single integrated circuit component. By doing so, the disclosure is not limited to any specific combination of hardware and software.

The above are only example embodiments of the disclosure and should not be used to limit the disclosure. For those skilled in the art, the disclosure may have various modifications and changes. Any modifications, equivalent replacements, improvements and the like within the spirit and principle of the disclosure shall fall within the scope of protection of the disclosure.

### INDUSTRIAL APPLICABILITY

As described above, a method and device for loading a system APP installation package, and a terminal provided by the embodiments of the disclosure have the following beneficial effect: the problem in the related art that a terminal is unable to start due to a data exception in a system APP installation package caused by an error made when a backup file is generated by copying the system APP installation package is solved, thereby achieving the effect of improving system stability and user experience.

1. A method for loading a system Application (APP) installation package, comprising:
before update processing of a system APP installation package, renaming the system APP installation package as a system APP installation backup package;
judging whether loading according to a system APP installation update package is successful, wherein the system APP installation update package is a system APP installation package acquired after updating a copied version formed by copying the system APP installation backup package; and
in a case that a judging result is that the loading according to the system APP installation update package is not successful, performing loading according to the system APP installation backup package.

2. The method as claimed in claim 1, wherein after performing the loading according to the system APP installation backup package, the method further comprises:
judging whether the loading according to the system APP installation backup package is successful;
in a case that a judging result is that the loading according to the system APP installation update package is not successful, acquiring an initial system APP installation package used during a first loading of a system device after delivery and, when the system APP installation package is updated each time, a different part of the updated system APP installation package relative to the initial system APP installation package;
combining the initial system APP installation package with the acquired different part to obtain a combined system APP installation package; and
performing the loading according to the combined system APP installation package.

3. The method as claimed in claim 2, wherein acquiring the initial system APP installation package used during the first loading of the system device after the delivery comprises:
renaming an initial system APP installation package generated during the first loading of the system device after the delivery as the initial system APP installation package.

4. The method as claimed in claim 2, wherein after performing the loading according to the combined system APP installation package, the method further comprises:
judging whether the loading according to the combined system APP installation package is successful;
in a case that a judging result is that the loading according to the combined system APP installation package is not successful, generating a system APP installation scanning package through scanning an APP installed to the system; and
performing the loading according to the system APP installation scanning package.

5. The method as claimed in claim 4, wherein after performing the loading according to the system APP installation scanning package, the method further comprises:
judging whether the loading according to the system APP installation scanning package is successful; and
in a case that a judging result is that the loading according to the system APP installation scanning package is not successful, performing the loading according to the initial system APP installation package generated during the first loading of the system device after the delivery.

6. A device for loading a system Application (APP) installation package, comprising:
a renaming component configured to, before update processing of a system APP installation package, rename the system APP installation package as a system APP installation backup package;
a first judging component, configured to judge whether loading according to a system APP installation update package is successful, wherein the system APP installation update package is a system APP installation package acquired after updating a copied version formed by copying the system APP installation backup package; and
a first loading component configured to, in a case that a judging result is that loading according to the system APP installation update package is not successful, perform loading according to the system APP installation backup package.

7. The device as claimed in claim 6, wherein the device further comprises:
a second judging component, configured to judge whether the loading according to the system APP installation backup package is successful;
an acquiring component configured to, in the case that a judging result is that loading according to the system APP installation update package is not successful, acquire an initial system APP installation package used during a first loading of a system device after delivery and, when the system APP installation package is updated each time, a different part of the updated system APP installation package relative to the initial system APP installation package;
a combining component, configured to combine the initial system APP installation package with the acquired different part to obtain a combined system APP installation package; and
a second loading component, configured to perform the loading according to the combined system APP installation package.

8. The device as claimed in claim 7, wherein the acquiring component comprises:
a renaming element, configured to rename an initial system APP installation package generated during the first loading of the system device after the delivery as the initial system APP installation package.

9. The device as claimed in claim 7, wherein the device further comprises:
a third judging component, configured to judge whether the loading according to the combined system APP installation package is successful;
a generating component configured to, in a case that a judging result is that the loading according to the combined system APP installation package is not successful, generate a system APP installation scanning package through scanning an APP installed to the system; and
a third loading component, configured to perform the loading according to the system APP installation scanning package.

10. The device as claimed in claim 9, wherein the device further comprises:
a fourth judging component, configured to judge whether the loading according to the system APP installation scanning package is successful; and
a fourth loading component configured to, in a case that a judging result is that the loading according to the system APP installation scanning package is not successful, perform the loading according to the initial system APP installation package generated during the first loading of the system device after the delivery.

11. A terminal, comprising the device as claimed in claim 6.

12. A terminal, comprising the device as claimed in claim 7.

13. A terminal, comprising the device as claimed in claim 8.

14. A terminal, comprising the device as claimed in claim 9.

15. A terminal, comprising the device as claimed in claim 10.
